(19) United States
(12) Patent Application Publication
(10) Pub. No.: US 2024/0013189 A1
(43) Pub. Date: Jan. 11, 2024

(54) COMPUTER-IMPLEMENTED SYSTEMS AND METHODS FOR PAYMENT ROUTING

(71) Applicant: Mastercard International Incorporated, Purchase, NY (US)

(72) Inventors: Nicholas Bryan Baguley, Salt Lake City, UT (US); Serenie Gagon, Draper, UT (US); Natesh Babu Arunachalam, Herriman, UT (US); Justin A. Harnish, Salt Lake City, UT (US); Cameron Bell, Draper, UT (US); Daniel Roper, Lehi, UT (US)

(73) Assignee: Mastercard International Incorporated, Purchase, NY (US)

(21) Appl. No.: 18/472,043

(22) Filed: Sep. 21, 2023

Related U.S. Application Data
(63) Continuation-in-part of application No. 18/145,627, filed on Dec. 22, 2022.
(60) Provisional application No. 63/294,406, filed on Dec. 29, 2021.

(51) Int. Cl. G06Q 20/22

(52) U.S. Cl. CPC G06Q 20/227

(57) ABSTRACT

A system for payment routing programmed to: receive a payment transaction message relating to a putative transaction, the payment transaction message containing putative transaction data identifying an accountholder and a transaction amount corresponding to the putative transaction; input historical transaction data for the accountholder and at least a portion of the transaction amount to a scaled score algorithm to generate scaled scores for corresponding potential settlement dates, each of the scaled scores representing the likelihood of settlement of the putative transaction from an account of the accountholder on the corresponding one of the potential settlement dates; retrieve, from a financial institution corresponding to the account, actual account balances for the account on the corresponding potential settlement dates; and retrain the scaled score algorithm using the actual account balances.

### RELATED APPLICATIONS

The current patent application is a continuation-in-part of identically-titled U.S. patent application Ser. No. 18/145,627, filed on Dec. 22, 2022, which, in turn, claims priority benefit to identically-titled U.S. Provisional Application No. 63/294,406, filed Dec. 29, 2021, and each of the foregoing applications is hereby incorporated by reference in its entirety into the current application.

The current patent application is filed contemporaneously with identically-titled U.S. patent application Ser. No. zz/xxx,xxx; U.S. patent application Ser. No. zz/xxx,xxx; U.S. patent application Ser. No. zz/xxx,xxx; and U.S. patent application Ser. No. zz/xxx,xxx, and the entire disclosure of each of the foregoing applications is hereby incorporated by reference herein.

### FIELD OF THE INVENTION

The present disclosure generally relates to computer-implemented payment methods, systems comprising computer-readable media, and electronic devices for payment routing according to a likelihood of settlement.

### BACKGROUND

Existing payment systems may enable merchants to submit putative transactions for approval. In some instances, a merchant may use a terminal or other payment device to initiate a payment transaction and will provide information relating thereto via a payment transaction network. Existing payment systems route payments according to predetermined settings of the merchant, potentially leading to suboptimal payment processing, or failed transactions. Additionally, the predetermined settings of the merchant lead to higher average costs associated with settling payment transactions. Improved routing methods are needed.

This background discussion is intended to provide information related to the present invention which is not necessarily prior art.

### BRIEF SUMMARY

The following brief summary is provided to indicate the nature of the subject matter disclosed herein. While certain aspects of the present invention are described below, the summary is not intended to limit the scope of the present invention.

A first aspect of the invention concerns a system for payment routing according to a likelihood of settlement. The system includes one or more processors and/or transceivers individually or collectively programmed to: receive a payment transaction message relating to a putative payment transaction, the payment transaction message containing putative payment transaction data identifying an account of an accountholder and a transaction amount corresponding to the putative payment transaction; input at least some of the putative transaction data to a scaled score algorithm to generate a scaled score representing the likelihood of settlement of the putative payment transaction on a date, the scaled score algorithm including a plurality of components each respectively outputting a value and the scaled score being based on the plurality of values; generate metadata regarding the scaled score by applying a plurality of contribution rules to the values, the metadata comprising significance indicators for the components with respect to the generation of the scaled score; and output the scaled score and the metadata regarding the scaled score in response to the payment transaction message.

A second aspect of the invention concerns a system for payment routing according to a likelihood of settlement, the system comprising one or more processors and/or transceivers individually or collectively programmed to: receive a payment transaction message relating to a putative payment transaction of an accountholder, the payment transaction message containing putative payment transaction data including a transaction amount corresponding to the putative payment transaction; identify a plurality of accounts corresponding to the accountholder based on the payment transaction message, the accounts being held with a plurality of financial institutions; and responsive to receipt of the putative transaction data, generate a scaled score representing the likelihood of settlement of the putative payment transaction on a date for each of accounts held with the financial institutions.

A third aspect of the invention concerns a system for payment routing according to a likelihood of settlement, the system comprising one or more processors and/or transceivers individually or collectively programmed to: receive a payment transaction message relating to a putative payment transaction of an accountholder, the payment transaction message containing putative payment transaction data including a transaction amount corresponding to the putative payment transaction; identify a plurality of accounts corresponding to the accountholder based on the payment transaction message; implement a payment split among the accounts, the payment split assigning a proportion of the transaction amount to each of the accounts; and generate a scaled score representing the likelihood of settlement of the assigned proportion of the transaction amount via each of the accounts on a date.

A fourth aspect of the invention concerns a system for payment routing according to a likelihood of settlement, the system comprising one or more processors and/or transceivers individually or collectively programmed to: receive a payment transaction message relating to a putative payment transaction, the payment transaction message containing putative payment transaction data identifying an accountholder and a transaction amount corresponding to the putative payment transaction; input historical transaction data for the accountholder and at least a portion of the transaction amount to a scaled score algorithm to generate a plurality of scaled scores, each of the scaled scores representing the likelihood of settlement of the putative payment transaction on a corresponding date and payment rail; output the scaled scores to a merchant in response to the payment transaction message; receive, from the merchant and in response to the output, feedback data for the putative payment transaction, the feedback data including a date of attempted payment processing for the putative payment transaction and an indicator of whether the attempted payment processing was completed; and retrain the scaled score algorithm using the feedback data.

A fifth aspect of the invention concerns a system for payment routing according to a likelihood of settlement, the system comprising one or more processors and/or transceivers individually or collectively programmed to: receive a payment transaction message relating to a putative payment transaction, the payment transaction message containing putative payment transaction data identifying an accountholder and a transaction amount corresponding to the putative payment transaction; input historical transaction data for the accountholder and at least a portion of the transaction amount to a scaled score algorithm to generate a plurality of scaled scores for a plurality of corresponding potential settlement dates, each of the scaled scores representing the likelihood of settlement of the putative payment transaction from an account of the accountholder on the corresponding one of the potential settlement dates; retrieve, from a financial institution corresponding to the account, actual account balances for the account on the corresponding potential settlement dates; and retrain the scaled score algorithm using the actual account balances.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various entities, in block schematic form, of an exemplary system for automatic selection of a payment rail in connection with payment transactions in accordance with embodiments of the present invention;

FIG. 2 illustrates various components of an exemplary computing device shown in block schematic form that may be used with the system of FIG. 1;

FIG. 3 is a flowchart illustrating at least a portion of the steps of a method for putative transaction routing in accordance with embodiments of the present invention;

FIG. 4 is a flowchart illustrating at least some of a plurality of variables that may be used in generating a scaled score for the putative transaction routing of FIG. 3, in accordance with embodiments of the present invention;

FIG. 5 is a flowchart illustrating at least a portion of the steps of another method for putative transaction routing in accordance with embodiments of the present invention;

FIG. 6 is a flowchart illustrating at least a portion of the steps of another method for putative transaction routing in accordance with embodiments of the present invention;

FIG. 7 is a flowchart illustrating at least a portion of the steps of another method for putative transaction routing in accordance with embodiments of the present invention;

FIG. 8 is a flowchart illustrating at least a portion of the steps of another method for putative transaction routing in accordance with embodiments of the present invention;

FIG. 9 is a flowchart illustrating at least a portion of the steps of a method for improving putative transaction routing in accordance with embodiments of the present invention; and

FIG. 10 is a flowchart illustrating at least a portion of the steps of another method for improving putative transaction routing in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing platforms for initiating a payment transaction are typically configured to implement a routing selection made pre-emptively by a corresponding merchant. Such systems may represent the best option among existing technologies available to merchants, but may nonetheless result in suboptimal payment processing, failed transactions and/or higher average costs associated with settling the payment transaction. Embodiments of the present invention provide an advanced alternative to existing routing methods.

### Exemplary System

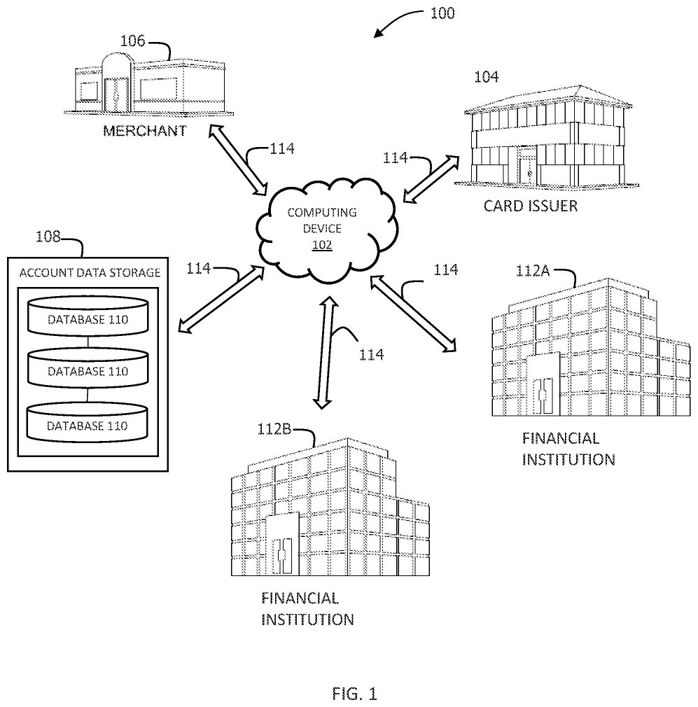

FIG. 1 depicts an exemplary environment 100 for payment routing according to embodiments of the present invention. The environment 100 may include a computing device 102, a card issuer 104, a merchant 106, an account data storage device 108, a database 110, one or more financial institutions 112A, 112B and the like, and communication links 114. The computing device 102 may be located within network boundaries of a large organization, such as a payment network or interchange. The computing device 102 may also be external to the organization.

More particularly, the card issuer 104, merchant 106, account data storage device 108, and database 110 may be in communication with the computing device 102 of the organization, which may include a trusted internal network or the like. In an embodiment, one or more account data storage devices 108 and databases 110 may be internal to the computing device 102, or alternatively, may be accessed by the computing device 102 via the communication links 114. In one or more embodiments, such remote access to the devices 108 and databases 110 may be managed under a common authentication management framework. The account data storage device 108 and databases 110 may be accessed by the computing device 102 to obtain account information in connection with putative transactions requested by the merchant 106 via the communication links 114, as discussed in more detail below.

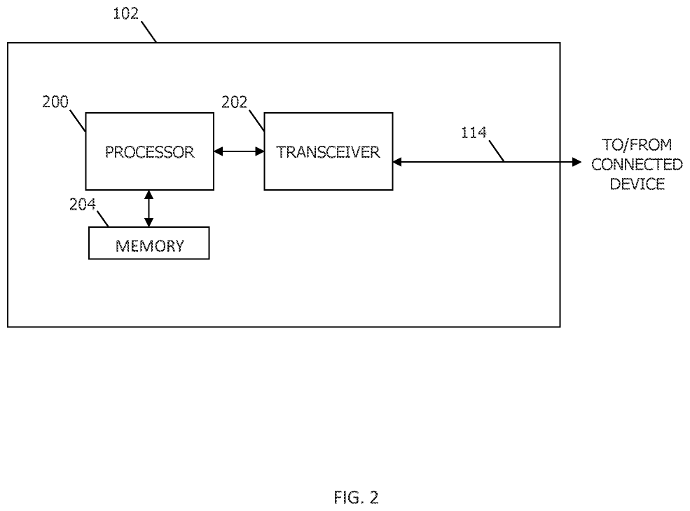

Turning briefly to FIG. 2, generally the computing device 102 may comprise tablet computers, laptop computers, desktop computers, workstation computers, smart phones, smart watches, and the like. Also, or in addition, the computing device 102 may include a plurality of copiers, printers, routers, switches, servers, and any other device that can connect to an internal or external network, and/or communication network. For example, the computing device 102 may also include a plurality of proxy servers, web servers, communications servers, routers, load balancers, and/or firewall servers, as are commonly known. Each computing device 102 may respectively include a processing element 200 and a memory element 204. Each computing device 102 may also respectively include circuitry capable of wired and/or wireless communication with the card issuer 104, merchant 106, account data storage device 108, databases 110, and/or financial institution 112, including, for example, transceiver element 202. Further, the computing device 102 may include software configured with instructions for performing and/or enabling performance of at least some of the steps set forth herein. In an embodiment, the software comprises programs stored on computer-readable media of memory elements 204.

Account holder information such as cardholder transaction data and/or account balance data acquired and/or provided by one or more of the computing device 102, the card issuer 104 and/or the financial institution(s) 112 may be saved to the account data storage device 108 and databases 110. Such data may be accessed by the computing device 102 in connection with putative transaction routing, as discussed in more detail below.

The computing device 102 may be encrypted such that no other devices may access data stored on the computing device 102, account data storage device 108, or database 110, unless authorized by the computing device 102. The computing device 102 may connect to an internal network or external network to access account holder information. In connection with accessing account holder information, the computing device 102 may read and/or make application programming interface (API) calls for account holder information stored in the account data storage device 108 and/or databases 110.

The computing device 102 may also or alternatively manage, make available and/or access data collected by an API accessible by one or more of the card issuer 104, merchant 106, and/or financial institutions 112A, 112B, where the API is implemented together with or separately from the account holder information API and is utilized to gather—automatically (e.g., on or after a last-occurring one of a plurality of potential settlement dates for a putative transaction) and/or manually—post-transaction data relating to the outcome of putative transactions for which scaled scores, recommendations or other output are provided in embodiments of the present invention, in each case as discussed in more detail below. Account data may also or alternatively be read and/or requested from other elements within the computing device 102 without departing from the spirit of the present invention.

It should also be noted that an “account” described herein may be any type of financial account, including, without limitation, a checking account, a savings account (and/or healthcare savings account), a mutual fund account, an annuity account, an investment account, a credit account, a debit account or the like. Moreover, it should be noted that a payment rail used in connection with an account may be any platform or network infrastructure that allows digital money transfers to be made between payers and payees including, without limitation, Automated Clearing House (ACH), credit card transactions, global payment company transactions, the Real-Time Payments (RTP) Network, blockchain, Society for Worldwide Interbank Financial Telecommunication (SWIFT), single euro payments area (SEPA) and the like.

The links 114 generally allow communication between the computing device 102, card issuer 104, merchant 106, account data storage devices 108, and financial institution 112.

The links 114 may include the Internet, cellular communication networks, local area networks, metro area networks, wide area networks, cloud networks, plain old telephone service (POTS) networks, and the like, or combinations thereof. The links 114 may be wired, wireless, or combinations thereof and may include components such as modems, gateways, switches, routers, hubs, access points, repeaters, towers, and the like. The communication links 114 may include wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The transceiver element 202 generally allows communication with the card issuer 104, merchant 106, account data storage device 108, and financial institution(s) 112. The transceiver element 202 may include signal or data transmitting and receiving circuits, such as antennas, amplifiers, filters, mixers, oscillators, digital signal processors (DSPs), and the like. The transceiver element 202 may establish communication via the communication links 114 wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver element 202 may utilize communication standards via the communication links 114 such as ANT, ANT+, Bluetooth™ low energy (BLE), the industrial, scientific, and medical (ISM) band at 2.4 gigahertz (GHz), or the like. Alternatively, or in addition, the transceiver element 202 may establish communication through connectors or couplers that receive metal conductor wires or cables, like Cat 6 or coax cable, which are compatible with networking technologies such as ethernet. In certain embodiments, the transceiver element 202 may also couple with optical fiber cables. The transceiver element 202 may respectively be in communication with the processing element 200 and/or the memory element 204.

The memory element 204 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 204 may be embedded in, or packaged in the same package as, the processing element 200. The memory element 204 may include, or may constitute, a “computer-readable medium.” The memory element 204 may store the instructions, code, code segments, software, firmware, programs, applications, apps, services, daemons, or the like that are executed by the processing element 200. In an embodiment, the memory element 204 respectively stores software applications. The memory element 204 may also store settings, data, documents, sound files, photographs, movies, images, databases, and the like.

The processing element 200 may include electronic hardware components such as processors. The processing element 200 may include digital processing unit(s). The processing element 200 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 200 may generally execute, process, or run instructions, code, code segments, software, firmware, programs, applications, apps, processes, services, daemons, or the like. For instance, the processing element 200 may execute software applications/programs stored on the memory element 204 in connection with performing all or some of the steps described herein. The processing element 200 may also include hardware components such as finite-state machines, sequential and combinational logic, and other electronic circuits that can perform the functions necessary for the operation of the current invention. The processing element 200 may be in communication with the other electronic components through serial or parallel links that include universal busses, address busses, data busses, control lines, and the like.

Through hardware, software, firmware, or various combinations thereof, the processing element 200 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized, and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### Exemplary Computer-Implemented Payment Routing Methods

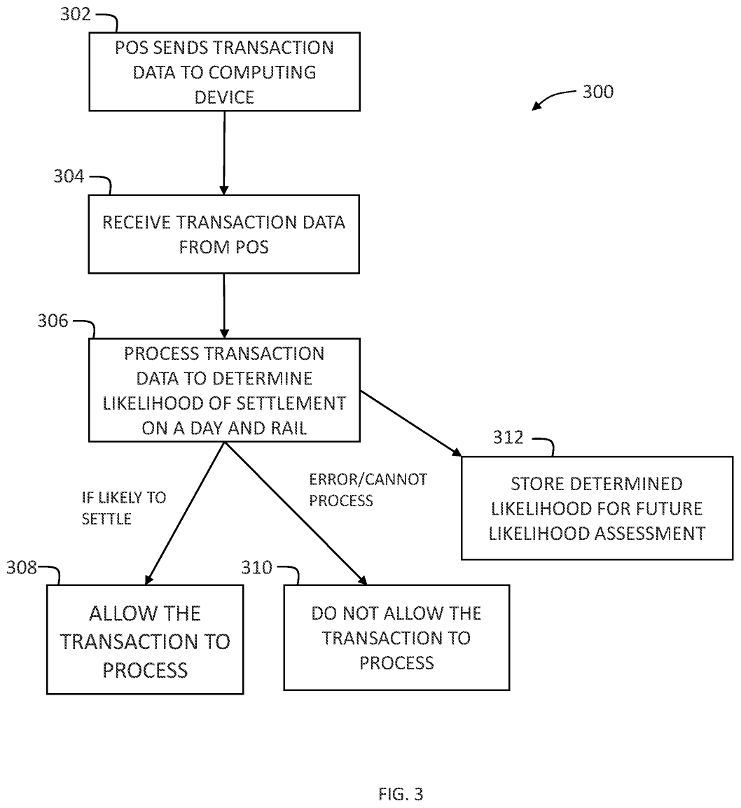

FIGS. 3-10 depict block flow diagrams associated with exemplary computer-implemented method(s) for payment routing and/or methods for improving payment routing. Some steps of each of the methods of FIGS. 3-10 may be performed concurrently as opposed to sequentially and may in some cases be performed in a different order. In addition, some steps may be optional. Moreover, the steps of any of the methods of FIGS. 3-10 may be performed together with the steps of any of the other methods of FIGS. 3-10 within the scope of the present invention.

The computer-implemented method(s) are described below, for ease of reference, as being executed by exemplary devices and components introduced with the embodiments illustrated in FIGS. 1 and 2. For example, the steps of the computer-implemented method(s) may be performed by the processor or transceiver of the computing device, at least in part through the utilization of processors, transceivers, hardware, software, firmware, or combinations thereof. In one or more embodiments, the steps set out below for a single putative transaction are substantially repeated in connection with executing a plurality of putative transactions on the same or similar payment networks. A person having ordinary skill will also appreciate that responsibility for all or some of such actions may be distributed differently among such devices or other computing devices without departing from the spirit of the present invention.

One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to FIG. 3, a payment processor and/or router may, in one or more embodiments, operate the computing device 102 to conduct the operations of steps 302-312 of method 300 discussed in more detail below.

Referring to step 302, a merchant may send putative transaction data—whether directly or via an acquirer—to the payment router. In one or more embodiments, the putative transaction data is entered at a point of sale (e.g., via a terminal) or the like at the merchant. However, one of ordinary skill will appreciate that a variety of entry points for the putative transaction data, such as a customer mobile device or the like, may be used without departing from the spirit of the present invention. Putative transaction data may include a customer ID number or other unique identifier assigned to a customer corresponding to a putative transaction, a transaction amount corresponding to the putative transaction, and a date by which the putative transaction must settle. One of ordinary skill will appreciate that the putative transaction data may include additional information, such as a selection of a payment rail by the merchant, without departing from the spirit of the present invention.

Referring to step 304, the payment processor may receive the putative transaction data after the merchant transmits the putative transaction data. In one or more embodiments, the putative transaction data will correspond to a payment transaction message. In some embodiments, the payment processor may extract or decode additional data from the putative transaction data, for example when the putative transaction data arrives to the payment processor as compressed data. In addition, the payment processor may convert the format of the putative transaction data in preparation for additional processing.

In one or more embodiments, the transaction data may include an industry-specific risk assessment. For example, the risk assessment may be transmitted in the format of a risk assessment score or may contain a notification suggestive of risk associated with a transaction in an industry (e.g., in an industry in which fraud is generally considered to be more likely). Such industries may include those more commonly associated with gambling, identity theft, unauthorized transactions (such as those executed by a minor or a subscription service), malicious websites, phishing, or the like, and those prone to settlement failures, chargebacks, reversals, or reimbursements. The risk assessment may affect the calculation of a scaled score or likelihood of settlement (discussed in more detail below).

Referring to step 306, the payment processor processes the transaction data to determine the likelihood of settlement for the putative transaction. Calculation of each likelihood of settlement may be according to principles and scores discussed in more detail below in connection with methods 400, 500. In one or more embodiments, a likelihood of settlement may be calculated for a plurality of days for one payment rail. Further, in one or more embodiments, the likelihood(s) may further be calculated across a plurality of payment rails. Accordingly, the payment processor may determine a highest likelihood for each of the payment rails, and compare the highest likelihoods of all the rails to, for example, select a payment rail and day representing an optimized combination of promptness and certainty of settlement. It should also be noted that, in certain embodiments, additional information (e.g., transaction costs, fraud likelihood and/or other data discussed in more detail below) may be considered when selecting a payment rail and/or day.

Also or alternatively, the payment processor may transmit or output the likelihoods of settlement to the merchant (e.g., in the form of scaled scores discussed in more detail below). The merchant may review the likelihoods of settlement, alone or together with other information (e.g., transaction costs, fraud likelihood and/or other data discussed in more detail below) and select a payment rail and day for processing of the putative transaction. The merchant may also transmit a transaction request with the selected payment rail and day (and any other information enabling transaction processing) to the payment processor. Responsive to receipt of the transaction request, the payment processor may initiate the corresponding transaction.

Referring to step 308, the payment processor may allow the transaction to process if the likelihood of settlement for the putative transaction exceeds a threshold. In one or more embodiments, if more than one likelihood exceeds the threshold, the payment processor may additionally specify the optimal day and/or rail from among the corresponding qualifying likelihoods for initiation of the transaction.

Referring to step 310, the payment processor may alternatively not allow the putative transaction to process if the likelihood of settlement for the putative transaction does not exceed the threshold.

In one or more embodiments, a low likelihood of settlement may result from an error. For example, the payment processor may use the customer ID to determine an available balance (e.g., from one or more account data storage databases). The payment processor may calculate a likelihood or corresponding score based on the available balance. The payment processor may calculate the likelihood or score based at least in part on the transaction amount, and/or data regarding the customer's spending patterns (e.g., regular payments, average monthly discretionary spending,) and/or deposit or payment history, with the likelihood or score reflecting a conclusion that it would be unlikely for a future available balance on the available day(s) of settlement to be adequate to cover the transaction amount. One of ordinary skill will appreciate that the likelihood and/or score calculations may reach different conclusions depending on the corresponding day and/or payment rail each relates to.

Referring to step 312, the payment processor may store the determined likelihood of settlement in a database. In one or more embodiments, a plurality of likelihoods—corresponding to a plurality of days extending up to and including a last possible day of settlement—may be stored for each available payment rail. Moreover, such a plurality of likelihoods may be calculated and stored for a plurality of available payments rails without departing from the spirit of the present invention. It should be noted that the payment processor may retrieve and utilize stored likelihoods or scores in connection with evaluating and/or calculating likelihoods of settlement for future putative transactions of, for example, the customer corresponding to the initial putative transaction.

In one or more embodiments, the payment processor may retrieve the stored likelihoods or scores and forward the stored likelihoods or scores on to the merchant for use in future transactions. For example, the merchant may use the stored likelihoods or scores as input for a local transaction decision model or manually take into consideration the stored likelihoods or scores for use in processing or declining future transactions. In one or more embodiments, the stored and/or transmitted information regarding calculation of scaled scores may include a plurality of factors or reasons, discussed in more detail below, driving the value of each of one or more of the scaled score(s).

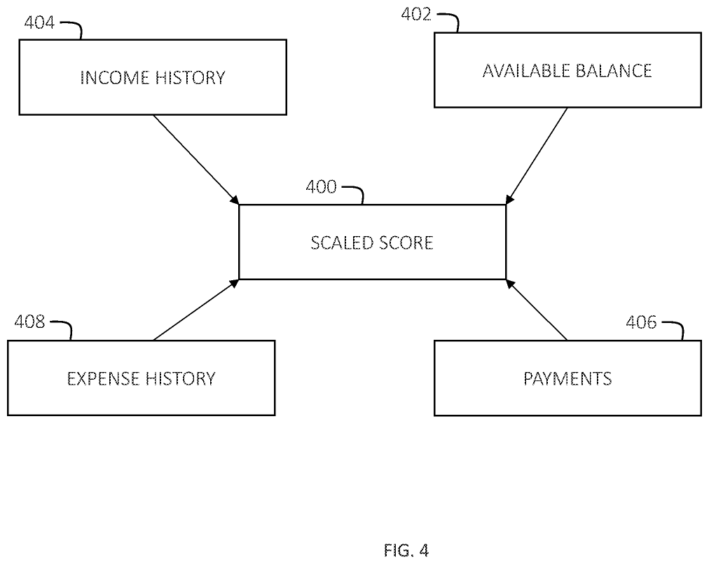

FIG. 4 depicts a block diagram of variables which may be used in deciding a scaled score 400. In one or more embodiments, the scaled score may comprise or be used in the calculation of the likelihood of settlement determination discussed in connection with method 300 above. More particularly, the scaled score may represent the likelihood of settlement of the putative transaction on at least one date that is no later than the latest date by which the putative transaction must settle for each of a plurality of potential payment rails. A plurality of dates may be assessed by the computing device and may be a range of dates including the attempted transaction date up to the latest date by which the transaction must settle. Each date and payment rail may receive a scaled score. Data relied on to generate each scaled score may be retrieved from or otherwise provided by one or more of a merchant, a card issuer, one of a plurality of financial institutions corresponding to the account in question, an account data storage device and a database.

The computing device or payment processor may generate the scaled score using a plurality of variables. For example, an available balance 402 may increase the scaled score 400 if the available balance 402, alone or when considered in connection with additional account transactions likely to occur in the account prior to settlement, is likely to be high enough to cover the transaction amount for the putative transaction. The reverse is also true where, for example, the available balance 402 and/or related factors make it less likely for the transaction amount to be covered on the settlement date. Moreover, an industry-specific risk assessment, where provided, may also be relied upon to generate the scaled score(s) 400.

The additional variables which may be considered in connection with the available balance 402 when calculating an estimated future available balance corresponding to a day of settlement include, without limitation, income (or deposit) history 404, payments history 406, and/or expense history 408. Moreover, significant factors in the calculation of one or more scaled score(s) may be outputted for further review and/or transmission to the merchant(s) in question.

Present account balance, frequency of insufficient funds events associated with the consumer, recent significant increases or decreases in spending compared to historical patterns and/or a history of increased or decreased spending during the time period in question, and/or recent significant increases or decreases in deposit activity compared to historical patterns and/or a history of increased or decreased deposits during the time period in question, may all comprise such factors.

Moreover, historical transaction data of additional/other accountholders may be used to derive one or more facts, factors, trends or the like used as variables for calculating scaled score(s). For example, in one or more embodiments, analysis of historical transaction data of accountholders with accounts with the same financial institution and/or account type as the account for which scaled score(s) are to be calculated may reveal that the financial institution and/or account type are likely to offer or be enrolled in an overdraft protection policy for non-sufficient funds events. One of ordinary skill will appreciate that analysis of historical transaction data of additional/other accountholders may reveal other aspects or characteristics of financial institution policies which may be considered during calculation of scaled score(s) within the scope of the present invention. It should also be noted that the filtering and analysis steps—and resulting outputs (e.g., facts, factors, trends or the like used as variables for calculating scaled score(s))—may be repeated for each account, rail and/or date for which a scaled score is generated according to the steps disclosed elsewhere herein.

Moreover, such analyses may also reveal broader behavioral and/or transactional trends of accountholders broadly and/or of similarly-situated accountholders, where such trends, patterns of facts may also be used as variables and/or otherwise during calculation of scaled score(s).

For example, analysis of historical transaction data of similarly-situated accountholders may include filtering out other accountholders who are not similarly-situated—based, for example, on average monthly deposit(s), expenditure(s), account type or privileges, or other factors relevant to clustering or grouping accountholders by typical behavior—followed by analyzing the historical transaction data of the remaining (similarly-situated) accountholders to reveal behavioral trends or patterns (e.g., with respect to any of the variables described above in connection with analyzing the present accountholder's historical transaction data to determined that individual's behaviors, trends and account characteristics).

Moreover, analysis of historical transaction data of similarly-situated accountholders may reveal trends, patterns and/or characteristics of transaction processes themselves. In one or more embodiments, a typical or expected processing delay and/or cost for the putative payment transaction may be determined with respect to each rail, account type and other relevant aspect of the putative payment transaction, based on analysis of historical transaction data of relevant similarly-situated accountholders.

Such variables or other information derived from analyses of other accountholders (e.g., similarly-situated accountholders) may be used in combination with variables and factors derived from analyzing the present accountholder's own individual data and/or may be used in place of the present accountholder's variables and factors (e.g., wherever the present accountholder lacks sufficient available historical transaction data to form the basis for account balance projections underlying the scaled score(s)).

In one or more embodiments calculation of the scaled score(s) may include a weighted summation or similar equation in which multiple significant variables or factors may contribute. Also or alternatively, in one or more embodiments, gradient-boosted decision tree(s) may be trained to calculate the scaled score(s) based on all or some of the variables or factors discussed herein. In one or more embodiments, an explicit regression gradient boosting algorithm may be trained on labeled or other data using, for example, a (differentiable) loss function. In one or more embodiments, a deep neural network may be used as a component of and/or otherwise to generate one or more values of the scaled score algorithm. In each case, the algorithm receiving historical transaction data and transaction amount data and outputting one or more scaled scores representing a likelihood of settlement may be referred to herein as a “scaled score algorithm.” One of ordinary skill will appreciate that algorithms and calculations, and underlying component(s), other than those exemplary ones listed herein may be used to calculate the scaled score(s) within the scope of the present invention.

In one or more embodiments, the scaled score algorithm includes a plurality of components, with each component outputting a value. For example, the components may include an account balance prediction component configured to determine an existing account balance and to analyze historical data of the accountholder in the account comprising prior withdrawals and deposits to project an account balance in the account on the date. For another example, the components may include a general transactional behavior component configured to analyze historical data comprising transactions of a plurality of accountholders (e.g., similarly-situated accountholders) to determine one or more factors impacting a projected account balance in the account on the date.

In one or more embodiments, the value may be numerical, logical, or otherwise. For example, the value of a first component configured to analyze historical transaction data of the present accountholder and/or one or more other accountholders (e.g., similarly-situated accountholders) may represent a likelihood that the account of the present accountholder has overdraft protection, and may be a scaled score value (e.g., from 0 to 1, with 1 representing a certainty that such protection exists for the account and/or that the protection is likely high enough to cover the present transaction amount should a non-sufficient funds event occur on a putative settlement date) and/or may be a logical value (e.g., “yes” or “no,” with “yes” representing a conclusion that such protection exists for the present account).

For another example, the value of a second and/or third component configured to analyze historical transaction data of the present accountholder and/or one or more other accountholders (e.g., similarly-situated accountholders) may be numerical and may represent a projected total deposit amount and/or projected total expenditure/withdrawal/debit amount for the present account over the period extending from the present date to the putative settlement date for which each scaled score is being calculated. One of ordinary skill will appreciate that a wide variety of logical and/or numerical output values may be generated by a wide variety of components of the scaled score algorithm for inclusion in the generation of the scaled score(s).

Moreover, in one or more embodiments, a confidence scalar may be a component of and/or be applied to one or more of the output values of the components of the scaled score algorithm. For example, where little or no historical transaction data is available for the present accountholder, and historical transaction data and/or behavioral/transactional trends for other similarly-situated accountholders is used instead and/or is more heavily relied on due to such deficiency, a confidence scalar may be applied to the corresponding output value(s) representing a lower confidence level. In the broader scaled score algorithm, such output value(s) may accordingly be weighted less heavily (i.e., treated with less authority or confidence) because they are derived mostly or entirely from indirect data (the historical transaction data of the other similarly-situated accountholders). Where metadata and/or circumstantial factors instead recommend a high level of confidence in an output value, a corresponding confidence scalar may accordingly be applied.

It should also be appreciated that adjustment mechanisms other than “scalars” may be used to adjust the weighting or relative importance of one or more factors, variables, component output values or the like within the scaled score algorithm within the scope of the present invention. In addition, periodicity, or the likelihood or degree of confidence in the likely occurrence of an event—such as a deposit or debit—based on consistency of related historical patterns of corresponding deposit(s) and/or debit(s) may be taken into account with a confidence scalar or another method of weighting adjustment within the scope of the present invention.

Further, various conversions between the output of such a weighted summation or other equation or algorithm and the preferred composite or score scale may be appropriate. It should also be noted that one or more embodiments may attach verbal descriptors or labels to portions of the scale for composite scores to more intuitively guide decision making (e.g., where a composite score in a favorable range is labeled “highly likely to settle”).

In one or more embodiments, within the scaled score algorithm, the significance of each factor used to calculate a scaled score may be weighted according to relative predictive usefulness. For instance, historical data may be analyzed to determine patterns or correlations between each such factor and the eventual occurrence (or non-occurrence) of insufficient funds events, and the factors may be weighted according to their relative usefulness in predicting such events.

For instance, one of ordinary skill will appreciate that pattern recognition may be employed to estimate or project the impact that each of variables 404, 406, 408 will have on the available balance 402 between the date on which the payment processor calculates a scaled score 400 and the date on which the settlement of the putative transaction is to occur. In one or more embodiments, machine learning models and/or algorithms may be used to generate patterns or correlations for historical income or deposits and corresponding day(s) (e.g., on a given day each month or quarter, a certain deposit is typically seen, at least within the previous eighteen (18) month period). For another example, such models may estimate the likelihood and amount of regular payments that will be made during the intervening period prior to settlement. Finally, other categories of spending (e.g., discretionary spending or the like) may be estimated on a monthly basis, and possibly in view of seasonal changes, to project other expenditures likely to occur during the intervening period. These components of a scaled score algorithm may output values which, when taken together—with or without confidence scalars or the like—generate a scaled score representing the likelihood of settlement of a transaction amount or a portion thereof on a given day and rail.

Various methods and models described herein may utilize machine learning programs or techniques to perform the analyses outlined herein. For instance, machine learning program(s) may recognize or determine patterns or correlations between customer spending or deposit behavior on the one hand, and date, time of the month and/or season on the other hand. The machine learning techniques or programs may include curve fitting, regression model builders, convolutional or deep learning neural networks, combined deep learning, pattern recognition, or the like. Based upon this data analysis, the computer-implemented methods and/or machine learning program(s) may estimate income and expenditures likely to occur in the customer's account in the intervening period between the time of calculation or estimation and the date of settlement.

In supervised machine learning, a computer-implemented method or program may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the computer-implemented method or program may be required to find its own structure in unlabeled example inputs.

The computer-implemented methods or programs herein may utilize classification algorithms such as Bayesian classifiers and decision trees, sets of pre-determined rules, and/or other algorithms to generate estimated income and expenses for each customer account.

Patterns discerned and implemented by embodiments of the present invention—seeking to discover general rule(s) that map inputs to outputs comprising correlations therebetween—may be generated based on review of individual accountholder data and/or data relating to groups of accountholders. For example, in one or more embodiments, an amount of a revenue or income deposit may be most reliably predicted at an individual level—that is, based solely on the present accountholder's own historical data—whereas a predicted date of deposit may most reliably be predicted based on a combination of the accountholder's own historical data and data from a broader accountholder group (e.g., capturing an average date of deposit across banks and/or employers subject to holiday calendars and other factors). In this manner, the algorithm generating the scaled score(s) may embody a plurality of components comprising rules, factors, models and the like trained and/or dependent on correlations and predictions for a plurality of variables and factors gained from analyzing individual accountholder data, data from a group of similarly-situated accountholders, and/or other relevant financial data.

It should again be noted that other correlations and/or rules may be determined from reviewing the historical data of the accountholder and/or similarly-situated accountholders at a given financial institution, such as predictions relating to the likelihood that an accountholder's financial institution will trigger non-sufficient funds or overdraft protection mechanisms to compensate for an accountholder's shortfall(s). Analysis of the historical transaction data of one or more such accountholder(s) may reveal widely-implemented, average and/or likely policy(ies) of the financial institution that are relevant to calculation of the scaled score(s) and/or risk value(s) calculated according to embodiments of the present invention, as discussed in more detail above.

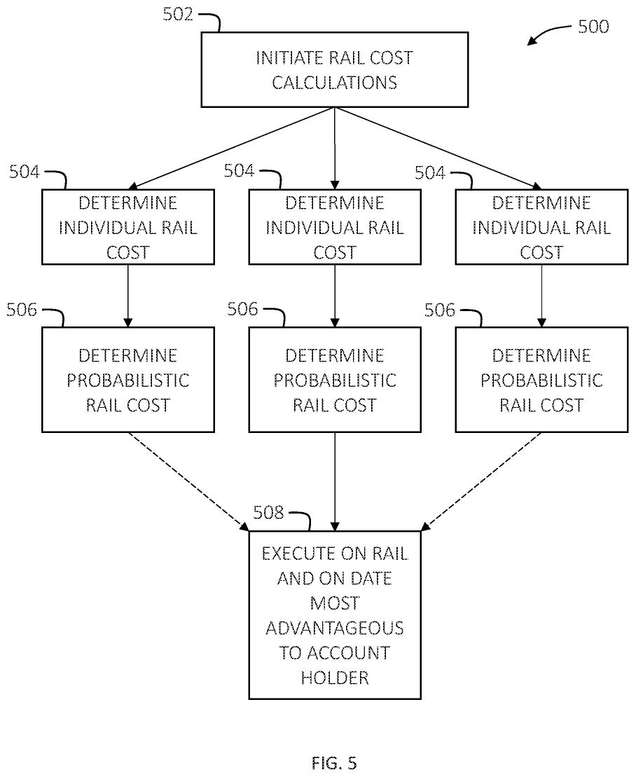

Referring to FIG. 5, a payment router and/or payment processor may perform one or more of the steps of the method 500, and may generally correspond to and/or embody the computing device 102. The payment router may generally calculate one or more costs corresponding to use of a plurality of rails, and weigh the calculated cost(s)—whether in isolation or in combination with one or more merchant preferences and/or the scaled score(s) representing likelihood of settlement discussed above—to select and/or enable selection of a rail along which to execute a putative transaction.

In one or more embodiments, the merchant's preference may be reflected in a risk tolerance (i.e., for failure of settlement), in a timing sensitivity (i.e., preferring earlier settlement), in a cost sensitivity, or in some weighted or unweighted combination of these factors. Accordingly, the merchant's preference may be unique and/or may vary from other merchants' preferences.

In one or more embodiments of the present invention, the payment router may access historical transaction records for each merchant. The payment router may submit the historical transaction data—e.g., reflecting transaction amounts, customers, chosen rails and/or dates of settlement (e.g., as compared to corresponding transaction initiation dates)—to a machine learning program or algorithm. The machine learning program or algorithm may automatically determine—for each merchant and based on pattern recognition—a merchant's preference(s) relating to risk tolerance and/or timing and/or cost sensitivity. The payment router may use this determined risk tolerance and/or timing and/or cost sensitivity information to select an optimized payment rail for each future transaction (e.g., according to the method 500 discussed in more detail below) without departing from the spirit of the present invention. One of ordinary skill will appreciate, however, that a merchant may manually input and/or select risk tolerance, timing sensitivity or the like for use by the payment router within the scope of the present invention.

In one or more embodiments, the payment router may recommend an optimal payment rail based at least in part on cost calculations. For example, the payment router may determine in real time whether the putative transaction will or is likely to settle on a particular date or time. In another example, the payment router may consider a risk of the putative transaction failing to settle and a number of days required for the putative transaction to settle or likely settle. In another example, the payment router may take into consideration a plurality of additional parameters set by the merchant in connection with determining the date and rail of an optimal settlement. Such parameters may include profit associated with the settlement, cost associated with the settlement, and risk associated with the settlement. In another example, the payment router may provide a ranking of the available rails, e.g., based on anticipated costs and risks. One skilled in the art will appreciate that the invention may take into consideration additional parameters—e.g., in connection with a variety of business lines—without departing from the spirit of the present invention.

Moreover, it should be appreciated that the steps outlined above for estimating, projecting and/or deriving one or more values for one or more of these parameters supporting recommendation(s) and/or selection(s)—for example, steps for determining cost(s) and likely time to settlement associated with a given rail—may be applicable to the steps of this method 500 within the scope of the present invention.

Referring to step 502, the payment router may initiate rail cost calculations in response to receiving a putative transaction request from a point of sale, merchant and/or acquirer.

Referring to step 504, the payment router may determine a rail cost for each of a plurality of rails. The rail cost may be determined by or in communication with one or more organization(s) responsible for operating the rail. For example, the rail cost may change on a daily basis or be consistent year-round. In another example, rail cost may be greater for a putative transaction settling on the date the transaction was initiated, with lesser costs appropriated for days after the transaction was initiated. In another example, the payment router may take into consideration the cost of an unsuccessful transaction. Unsuccessful transaction costs may be the same every day and/or depend on the cost of the putative transaction.

In some embodiments, the cost of a transaction may also influence the rail cost. For example, higher cost transactions may have a higher rail cost, while lower cost transactions may have a lower rail cost.

In some embodiments, a plurality of data points gathered by the payment router may not suggest a date by which a rail may settle. For example, a rail may not have a date by which the transaction must settle, in which case the payment router may take into consideration the probability a rail may settle on a plurality of days instead of approaching a latest date by which the rail must settle. However, one skilled in the art will readily appreciate that other factors may be used in determining the rail cost and date by which the rail may settle without departing from the spirit of the invention.

In some embodiments, a rail may settle a putative transaction on the date the putative transaction was initiated. In another example, a rail may be certain to settle a putative transaction on the date immediately after the date the putative transaction was initiated. In another example, a rail may settle on a date determined by the merchant.

Referring to step 506, the payment router may determine a probabilistic rail cost for prospective days upon which the putative transaction may settle. In some embodiments, the payment router may determine the probabilistic rail cost for prospective days upon which the putative transaction may settle by at least considering the rail cost and a probability of the putative transaction settling.

In some embodiments, the probability of the putative transaction settling may be based at least in part on factors discussed earlier. For example, the probability of the putative transaction settling may be based at least in part on the scaled score determined in method 400 discussed above. In another example, the probability of the transaction settling may also be based at least in part on a merchant's individual preferences. One skilled in the art will appreciate that other factors may be used in determining the probability of a putative transaction settling without departing from the spirit of the invention.

In some embodiments, the probability of the transaction settling may be based at least in part on whether a particular rail allows settlements to occur on specific days. For example, some rails may allow transactions to occur only on the date the putative transaction was attempted. In another example, some rails may allow transactions to occur only on the date immediately following the date the putative transaction was attempted. In another example, some rails may allow transactions to occur on all days, wherein the likelihood of the transaction settling decreases each day after the merchant initiated the transaction.

In some embodiments, the payment router may determine the probabilistic rail cost by considering the probability of the transaction settling via a specific rail and by a specific date. For example, the payment router may determine the probabilistic rail cost by finding a product of the probability that a transaction will settle on a specific rail and day and the cost of the transaction settling on that rail and day, for all considered days, and adding the products for all considered days. However, one skilled in the art will appreciate that the probabilistic rail cost can be determined by interpolating or removing parameters without departing from the spirit of the invention.

Referring to step 508, the payment router may execute the transaction on the rail and date most advantageous to the merchant. For example, the most advantageous rail and date for the merchant may be determined by the rail having the lowest probabilistic rail cost or by the preferences of the merchant. For another example, the most advantageous rail and date for the merchant may be determined by the rail having the lowest probabilistic rail cost, within a required range of settlement dates, and with a threshold composite score or score indicator. However, one skilled in the art will appreciate that other parameters may be used in determining the most advantageous rail for the merchant, and/or that determinations regarding which rail may be most advantageous for the corresponding customer may also be taken into account, without departing from the spirit of the invention.

In some embodiments, the payment router may store any data resulting from calculations in an account data storage device or plurality of databases for use in future calculations related to each corresponding account, or for use in future putative transactions.

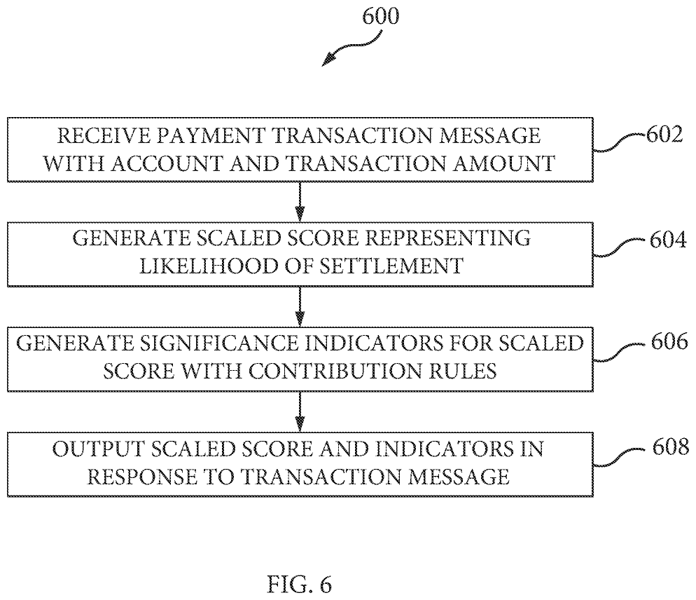

Referring to FIG. 6, a payment router and/or payment processor may perform one or more of the steps of the method 600, and may generally correspond to and/or embody the computing device 102.

Referring to step 602, the payment router may receive a payment transaction message with account and transaction amount data. In one or more embodiments, the payment transaction message will describe a putative payment transaction between a merchant and a payer. The merchant may transmit the payment transaction message. The account data identifies an account of the payer (i.e., accountholder).

Referring to step 604, a scaled score representing a likelihood of settlement of the putative payment transaction may be generated. In one or more embodiments, the scaled score algorithm generates the scaled score. The likelihood of settlement may be tied to a particular day or date. Moreover, a scaled score may be generated for a plurality of dates—typically but not necessarily occurring on consecutive business days—and/or for a plurality of payment rails. Put differently, a scaled score may be generated for each combination of a date and a payment rail. In one or more embodiments, other variables or factors may additionally vary—such as, for example, the account(s) from which the transaction is to be settled—such that a scaled score is generated for each unique combination of these variables (e.g., date, payment rail, account, etc.).

Referring to step 606, significance indicators for each of the scaled scores may be generated using contribution rules. In one or more embodiments, the scaled scores may be calculated in accordance with the method 400 described above. The contribution rules may be configured to record and trace the constituent outputs of components of the scaled score algorithm and attribute levels of influence or importance to each reflecting relative influence in generating each of the scaled scores.

More particularly, it may be appreciated from the discussion above in connection with the method 400 that scaled scores may be influenced by a variety of components of the scaled score algorithm (e.g., the account balance prediction components and/or subsidiary deposit and/or debit projection subcomponents, and/or the general transactional behavior component discussed above) to a greater or lesser degree depending on the data and facts submitted to the algorithm for each score and unique combination of factors or variables. For example, in a first instance, a scaled score may be poor and indicative of a low likelihood of success for settlement because the payer lacks a sufficiently lengthy history of regular deposits (correlating with a paycheck, for example) to establish periodicity bolstering confidence in the availability of funds on the date of putative settlement as a result of such deposit(s). In a second instance, however, a scaled score that is poor and indicative of a low likelihood of success for settlement may be primarily influenced by a pattern of higher-than-average spending from the account by the payer during the period in question. The contribution rules may be configured to output metadata comprising the significance indicators, with the significance indicators describing or reflecting those components or component outputs of the scaled score algorithm which weighed most heavily on or most heavily influenced—whether positively or negatively—the final scaled score in each case.

Moreover, the significance indicators may be the output of intermediate refinement processing steps converting a raw form of metadata to one more easily understood by the merchant and/or payer. For example, a natural language processing model may take the raw metadata output or indicators from the contribution rules and describing the calculation of the scaled score at issue as input and may output natural language narratives comprising or describing the significance indicators and the most important outputs or components of the scaled score algorithm in calculating each scaled score. In the first instance given as an example above, the significance indicator may read “The payer has not established a regular pattern of significant deposits to the proposed account, which significantly lowered this score.” In the second instance given as an example above, the significance indicator may read “The payer typically spends at higher-than-average levels over the intervening time period before the putative transaction is to be settled, which significantly lowered this score.” One of ordinary skill will appreciate that the form of the significance indicators, configuration of the contribution rules, and types of raw metadata relied on for generating the significance indicators, may vary within the scope of the present invention.

Referring to step 608, each of the scaled scores may be output with one or more of the corresponding significance indicators. In one or more embodiments, the scaled scores and significance indicators are output to a payment decisioning module or component of the payment router. The payment decisioning module may determine a highest likelihood from among those output for each unique combination of variables or factors (e.g., date, payment rail, account, etc.). In a simple embodiment, a single payment rail and account are considered—and other variables or factors are likewise held constant—such that a single scaled score is generated and output for each of a plurality of dates, and the date with the highest likelihood of settlement or score may be selected for processing of the putative payment transaction. However, in one or more embodiments, scaled scores will also be generated based on varying the payment rail, account, or the like, within the scope of the present invention.

Also or alternatively, the payment processor may transmit or output the likelihoods of settlement or scaled scores, along with the corresponding significance indicators, to the merchant. The merchant may review the scaled scores and significance indicators, alone or together with other information (e.g., transaction costs, fraud likelihood and/or other data discussed in more detail below) and select a day (and, in one or more embodiments, payment rail, account and the like) for processing of the putative transaction.

In one or more embodiments, the payment decisioning module and/or merchant may use the significance indicators as context enabling a multi-dimensional decisioning process that goes beyond the scaled scores.

Returning to the first instance example set forth above, the merchant may incorporate knowledge and/or inferences not considered or properly weighted by the scaled score algorithm in generating the corresponding scaled score(s)—such as, for example, where the merchant is confident that the payer has secure, if only recently-obtained, employment supporting the conclusion that regular significant deposits should be expected—to decide how and if to process the putative transaction.

Returning to the second instance example set forth above, the merchant may again rely on knowledge and/or inferences not considered or properly weighted by the scaled score algorithm—such as, for example, where the merchant is confident that the payer is not making significant other or additional purchases in the interim—to decide how and if to process the putative transaction.

Put differently, the significance indicators may permit the payment decisioning module and/or merchant to implement a customized decisioning process which might result in selection of a date, rail, account or the like other than what the scaled scores might suggest on their face.

It should be noted that not all significance indicators generated by the contribution rules may be transmitted to and/or relied on by the payment decisioning module and/or the merchant. For example, in one or more embodiments, a threshold of importance may be applied to each significance indicator to determine whether it should be included in the transmission to and/or input relied on by the payment decisioning module and/or merchant. Accordingly, a plurality of alternative significance indicators which do not meet or exceed their respective relevance or importance thresholds may be omitted from the transmission to the merchant and/or input taken by the payment decisioning module.

It should also be noted that, in certain embodiments, additional information (e.g., transaction costs, fraud likelihood and/or other data discussed in more detail below) may be considered when selecting a payment rail and/or day.

The merchant may also transmit a transaction request with the selected day (and, optionally, rail, account and the like) to the payment processor, responsive to the merchant's receipt of the scaled scores and corresponding significance indicators. Responsive to receipt of the transaction request, or to a selection by the payment decisioning module, the payment processor may initiate the corresponding transaction.

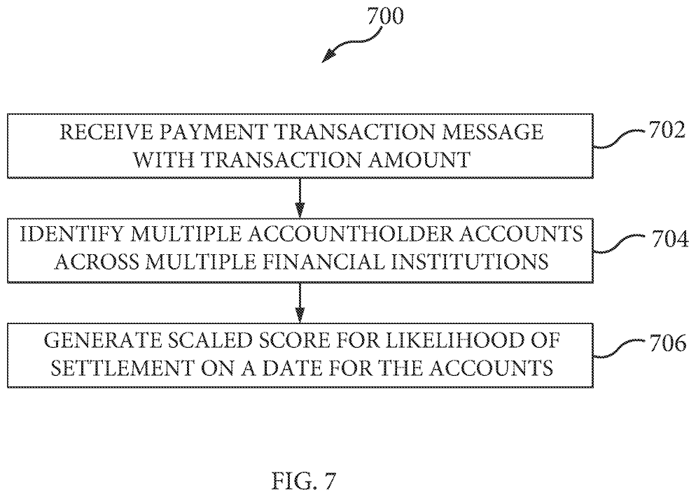

Referring to FIG. 7, a payment router and/or payment processor may perform one or more of the steps of the method 700, and may generally correspond to and/or embody the computing device 102.

Referring to step 702, the payment router may receive a payment transaction message with transaction amount data. In one or more embodiments, the payment transaction message will describe a putative payment transaction between a merchant and a payer (i.e., accountholder). The merchant may transmit the payment transaction message.

Referring to step 704, multiple accountholder accounts across multiple financial institutions may be identified. In one or more embodiments, the multiple accounts and corresponding financial institutions will be predetermined and identified through reference to the settings and data input provided during the accountholder's setup processes with the payment router, discussed in more detail above. For example, in connection with enrollment and account setup for an open banking service provided and/or implemented by the payment router, the accountholder may specify the financial institutions and accounts, e.g., using corporate name, routing and account numbers, and the like.

The accountholder may also specify or associate a transaction type with a particular subset of all possible accountholder accounts, for example where the accountholder wishes certain accounts to be considered for settlement of certain transaction types, where a different group of accounts should be considered for settlement of other transaction types. Accordingly, the multiple accountholder accounts may be identified at least in part by matching a transaction type described in the payment transaction message against the accountholder's pre-determined transaction type and retrieval of the corresponding qualifying accounts.

In one or more embodiments, however, the payment router may locate, identify and/or select one or more of the multiple accounts across multiple financial institutions on behalf of the accountholder (i.e., payer).

Also or alternatively, one or more of the multiple accounts and financial institutions may be specified or identified during or in connection with the putative payment transaction. For example, the merchant and/or payment router may receive transmissions from an open banking mobile application or other process running on a consumer mobile device and configured to receive selections and/or data identifying the accounts and/or institutions and transmit same to the merchant and/or payment router.

Referring to step 706, a scaled score for each of the multiple accounts of the multiple financial institutions may be generated, with each scaled score representing a likelihood of settlement of the putative payment transaction from the corresponding account. In one or more embodiments, the scaled score algorithm generates the scaled score in accordance with the description of method 400 above. Moreover, scaled scores may be generated for a plurality of dates—typically but not necessarily occurring on consecutive business days—and/or for a plurality of payment rails, for each of the plurality of accounts. Put differently, a scaled score may be generated for each combination of a date, a payment rail and an account. It should be appreciated that, in one or more embodiments, additional factors or variables may be introduced and a corresponding scaled score may be generated for each unique combination of same by the scaled score algorithm within the scope of the present invention.

In addition, in one or more embodiments, a projected cost for each unique combination of factors or variables (e.g., date, rail and account) may be generated in accordance with discussion of the method 500 set forth above. Also or alternatively, significance indicators may be generated and/or transmitted or otherwise output as described in connection with the method 600 set forth above.

In an example, a first account of the accountholder may be held at a first account of the plurality of accounts at a first financial institution of the plurality of financial institutions, and a second account of the accountholder may be held at a second account of the plurality of accounts at a second financial institution of the plurality of financial institutions. A first preferred payment rail (e.g., via automated clearing house (ACH) transaction) for the first account may be used to generate scaled scores for the first account across a period of ten (10) consecutive business days. A second preferred payment rail (e.g., via a debit card transaction) for the second account may be used to generate scaled scores for the second account across the same period of ten (10) consecutive business days. Accordingly, twenty (20) scaled scores across the two (2) accounts may be generated.

It should also be noted that one or more of projected rail costs, significance indicators or other information described above may be generated for association and output with the scaled scores without departing from the spirit of the present invention.

The scaled scores (and any other information generated in connection therewith) may be output. In one or more embodiments, the scaled scores are output to a payment decisioning module or component of the payment router. The payment decisioning module may determine a highest likelihood from among those output for each unique combination of variables or factors (e.g., date, payment rail and account). In a simple embodiment, the date, rail and account with the highest likelihood of settlement or score may be selected for processing of the putative payment transaction. However, in one or more embodiments, projected costs, significance indicators and other information may lead to selection of an alternative combination of date, rail and account within the scope of the present invention.

Also or alternatively, the payment processor may transmit or output the likelihoods of settlement or scaled scores and any additional information discussed above, to the merchant. The merchant may review the scaled scores, alone or together with other information (e.g., transaction costs, fraud likelihood and/or other data discussed in more detail above) and select a day, rail and account for processing of the putative transaction.

The merchant may also transmit a transaction request with the selected day, rail and account to the payment processor, responsive to the merchant's receipt of the scaled scores.

Responsive to receipt of the transaction request, or to a selection by the payment decisioning module, the payment processor may initiate the corresponding transaction.

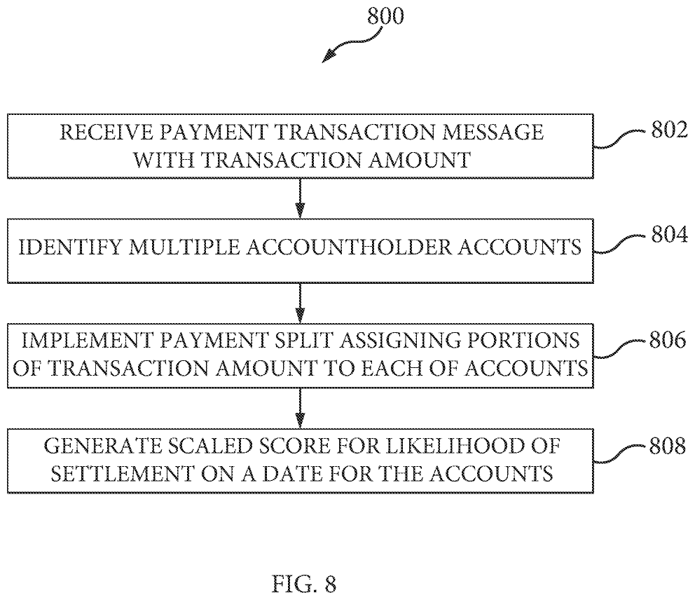

Referring to FIG. 8, a payment router and/or payment processor may perform one or more of the steps of the method 800, and may generally correspond to and/or embody the computing device 102.

Referring to step 802, the payment router may receive a payment transaction message with transaction amount data. In one or more embodiments, the payment transaction message will describe a putative payment transaction between a merchant and a payer (i.e., accountholder). The merchant may transmit the payment transaction message.

Referring to step 804, multiple accountholder accounts may be identified. In one or more embodiments, the multiple accounts may be with a single financial institution or across multiple corresponding financial institutions. The accounts may be predetermined and identified through reference to the settings and data input provided during the accountholder's setup processes with the payment router, discussed in more detail above. For example, in connection with enrollment and account setup for an open banking service provided by the payment router, the accountholder may specify the financial institution(s) and accounts, e.g., using corporate name, routing and account numbers, and the like.

In one or more embodiments, however, the payment router may locate, identify and/or select one or more of the multiple accounts on behalf of the accountholder (i.e., payer).

Also or alternatively, one or more of the multiple accounts may be specified or identified during or in connection with the putative payment transaction. For example, the merchant and/or payment router may receive transmissions from an open banking mobile application or other process running on a consumer mobile device and configured to receive selections and/or data identifying the accounts and transmit same to the merchant and/or payment router.

Referring to step 806, a payment split assigning portions of the transaction amount to each of the multiple accounts may be implemented. In one or more embodiments, enrollment and account setup with the payment router (e.g., in connection with an open banking service) may include specification by the accountholder and/or the payment router of one or more payment split(s). It should also be appreciated that any such enrollment and account setup process may include specification by the accountholder and/or payment router of one or more transaction types—which may be specified in a variety of ways, including, for example, using merchant category codes or other taxonomies, using vendor or payee information, and/or according to other methodologies—to which each specified payment split may be applied. Also or alternatively, as discussed in more detail above in connection with method 700, the account(s) and/or payment rail(s) specified may be assigned partly or entirely based on the transaction type without departing from the spirit of the present invention.

The plurality of accounts may include those categorized in two or more of the following account categories: credit, debit, savings, checking, and health savings account (HSA).

Each payment split may comprise a definition apportioning a transaction amount, amount range, amount percentage, or other payment responsibility to each of the plurality of accounts which may be used to settle the putative payment transaction. Payment split definitions may be variously constructed, and alternative definitions may be used to assess the same putative payment transaction.

For example, a simple percentage of the total transaction amount for the putative payment transaction may be assigned to each of the accounts which are to participate in settlement of the transaction and/or for which scaled scores are to be generated in connection with determining likelihood of settlement for the putative payment transaction for each given combination of settlement date, payment rail, and the like. For another example, a fixed dollar amount of the putative payment transaction may be assigned to one or more of the accounts. In the latter case, a fixed dollar amount may be assigned to less than all the accounts to be evaluated with a scaled score in connection with the putative payment transaction—such as where exemplary accounts A and B are assigned $50 and $100, respectively—with the remaining amount of the total transaction amount being assigned to one or more remaining ones of the accounts (e.g., where an account C is assigned the total transaction amount minus $150 or where accounts C and D are respectively apportioned a percentage of the remaining funds required). One of ordinary skill will appreciate that various percentages, fixed amounts, and even logical statements (e.g., if/then statements) may be incorporated into a payment split definition within the scope of the present invention.

In addition, as noted above, alternative definitions for the same putative payment transaction, date, rail and combination of accounts may be used to generate additional scaled scores for the transaction. For example, where the same three (3) accounts are to be evaluated for the putative transaction, with two (2) payment rails being implemented across those three (3) accounts and five (5) possible settlement dates being considered, several alternative definitions may be used to arrive at several corresponding sets of scaled scores generated by the scaled score algorithm. For example, the accountholder and/or payment router may have specified (e.g., in a definition and/or otherwise) in an enrollment and setup process that, for the type of transaction under consideration, it would be preferable to first satisfy a maximum proportion of the putative total transaction amount using a first account of the plurality of accounts, provided the first account is not left depleted beyond a certain amount. The accountholder and/or payment router may have further specified apportionment of any remaining amounts across the remaining accounts. Accordingly, alternative payment split definitions may be used to generate scaled scores which may be evaluated against such goals (e.g., specified during enrollment and setup and/or generally derived from payment router logic) to determine the optimum balance with likelihood of settlement, cost, and/or other goals of the accountholder.

Referring to step 808, a scaled score may be generated for each combination of payment split definition and group of accounts, and/or any other factors or variables discussed herein. Each scaled score may be for each account, day and rail under consideration, or may be a composite scaled score representing the likelihood of settlement of the transaction across the multiple accounts for a given combination of payment split definition, rail and accounts. Put differently, each account specified by the payment split definition may receive an individual scaled score for the assigned portion of the total transaction amount and a given day and rail, and/or a combined or composite scaled score may be generated for the combination of accounts specified by the payment split definition to satisfy the total transaction amount on a given day and rail(s). In one or more embodiments, in either case, additional scaled scores and/or combined or composite scaled scores are generated for each of the plurality of potential or alternative settlement dates under consideration.

In one or more embodiments, the scaled score algorithm generates the scaled score in accordance with the method 400 discussed above. Moreover, scaled scores may be generated for a plurality of dates (e.g., including the original date and one or more alternative or additional dates corresponding to alternative scaled scores)—typically but not necessarily occurring on consecutive business days—and/or for a plurality of payment rails. Put differently, a scaled score may be generated for each combination of a payment split definition, group of accounts, date, and payment rail associated with each of the group of accounts.

In addition, in one or more embodiments, a projected cost for each unique combination of factors or variables (e.g., date, rail and account) may be generated in accordance with discussion of the method 500 set forth above. Also or alternatively, significance indicators may be generated and/or transmitted or otherwise output as described in connection with the method 600 set forth above.

It should also be noted that one or more of projected rail costs, significance indicators or other information described above may be generated for association and output with the scaled scores without departing from the spirit of the present invention.

The scaled scores (and any other information generated in connection therewith) may be output. In one or more embodiments, the scaled scores or a representation or embodiment thereof are output to a payment decisioning module or component of the payment router. The payment decisioning module may determine a highest likelihood from among those output for each unique combination of variables or factors (e.g., payment split definition, date, payment rail and accounts). In a simple embodiment, the payment split definition, date, rail and accounts with the highest likelihood of settlement or score may be selected for processing of the putative payment transaction. However, in one or more embodiments, projected costs, significance indicators and other information may lead to selection of an alternative combination of date, rail and account within the scope of the present invention.

Also or alternatively, the payment processor may transmit or output the likelihoods of settlement or scaled scores (and/or a representation or embodiment thereof) and any additional information discussed above (e.g., transaction costs), to the merchant. The merchant may review the scaled scores, alone or together with other information (e.g., transaction costs, fraud likelihood and/or other data discussed in more detail above) and select a day, rail and account for processing of the putative transaction.

The merchant may also transmit a transaction request with the selected day, rail and accounts to the payment processor, responsive to the merchant's receipt of the scaled scores. For example, in one or more embodiments, the transaction cost for each account utilized under a payment split definition may be calculated on a given day, and an alternative transaction cost for each account under the payment split definition may be calculated on a second day. The scaled scores corresponding to the accounts and the first and second days may be considered in conjunction with the transaction costs and the alternative transaction costs to select the day on which to attempt transaction processing for the putative payment transaction.

Responsive to receipt of the transaction request, or to a selection by the payment decisioning module, the payment processor may initiate the corresponding transaction.

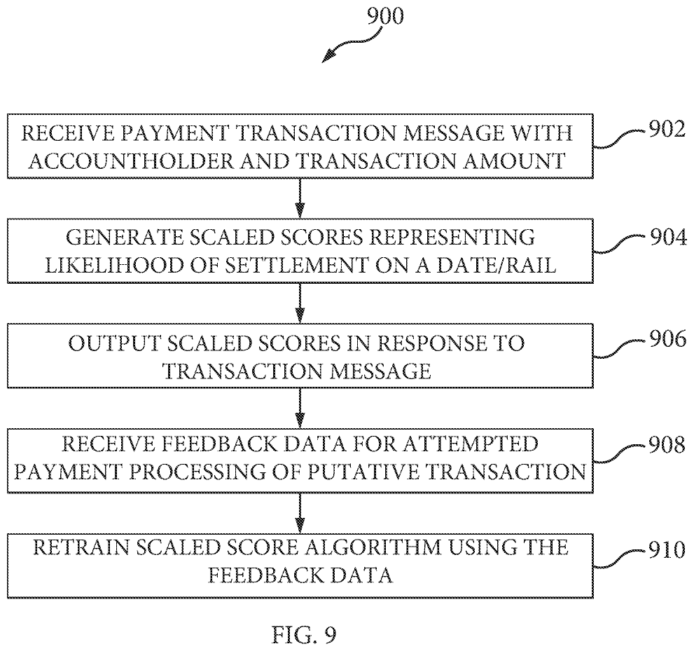

Referring to FIG. 9, a payment router and/or payment processor may perform one or more of the steps of the method 900, and may generally correspond to and/or embody the computing device 102.

Referring to step 902, the payment router may receive a payment transaction message with accountholder and transaction amount data. In one or more embodiments, the payment transaction message will describe a putative payment transaction between a merchant and a payer (i.e., accountholder) for the transaction amount. The merchant may transmit the payment transaction message.

Referring to step 904, a scaled score representing a likelihood of settlement of the putative payment transaction may be generated. In one or more embodiments, the scaled score algorithm generates the scaled score in accordance with method 400 described above. Moreover, a scaled score may be generated for a plurality of dates—typically but not necessarily occurring on consecutive business days—and/or for a plurality of payment rails. Put differently, a scaled score may be generated for each combination of a date and a payment rail. One of ordinary skill will appreciate that a scaled score may be generated for each unique combination of date and/or payment rail and one or more additional variables or factors—such as, for example, participating account(s) or other aspects of a putative transaction that are likely to impact likelihood of settlement—within the scope of the present invention.

Referring to step 906, the scaled scores may be output in response to the transaction message. For example, the scaled scores may be output to a merchant originating the transaction message and which is responsible for finalizing a transaction request corresponding to the putative payment transaction. For example, the putative transaction may be a recurring transaction and the merchant may submit the payment transaction message to the payment router specifically to elicit the scaled scores that indicate the likelihood that the transaction will settle on each of a variety of days (e.g., across the next five (5) business days) and/or across blocks of days (e.g., across the first five (5) business days of each month over the following year). The scaled scores thus help the merchant decide which date, account and/or payment rail(s) to target to increase likelihood of success, decrease costs, and otherwise achieve goals outlined herein.

Referring to step 908, feedback data for attempted payment processing of the putative payment transaction may be received. In one or more embodiments, periodically or on or after a last-occurring one of the dates for which scaled scores were generated and output to the merchant, the feedback data may be reported out from the merchant or affiliated entity to the payment router. For example, the feedback data may be transmitted from the merchant or affiliated entity to the payment router via an API maintained and/or accessible to, and/or that transmits data to, the payment router. The transmission may be automated, and may occur intermittently, periodically, continuously and/or based on a trigger (e.g., approach or passage of the aforementioned last-occurring day in the group of potential dates for settlement).

Moreover, the payment router may automatically designate the feedback data for use in retraining. For example, each of the payment transaction message, the scaled scores, and the feedback data (and, optionally, the transaction request itself) may be labeled with a unique identifier (e.g., a unique alphanumeric code or the like) that may be used to link such data together with the same payment transaction message and automatically designate same for retraining processes.

In one or more embodiments, the feedback data includes one or more of: a date of initiation of an attempted transaction corresponding to the putative payment transaction; an indicator of whether the attempted transaction was successfully completed; a date of successful completion of the attempted transaction; and a rail of the attempted transaction, the rail being one of multiple different rails represented in the scaled scores output to the merchant.

Referring to step 910, the feedback data may be used to retrain the scaled score algorithm. For example, the feedback data may describe which day(s) were chosen by the merchant for the attempted payment processing and/or whether the attempted payment processing was successful. Moreover, regression or clustering analyses and techniques may be used to group factors or variables relied on by the scaled score algorithm in generating the scaled scores and which were apparently important to the merchant in selecting the date, account and/or payment rail used for the attempted payment processing. Put differently, if a relatively large dataset reflecting a multitude of attempted payment processing transactions reveals that one or more merchants consistently select a date that is after the fifth (5^{th}) of each month for attempted payment processing, even where the scaled scores are more favorable in preceding days, the retraining may more heavily weight or otherwise favor the corresponding time period(s) in future scaled score generation.

For another example, wherever the feedback data reveal that success rates for attempted payment transactions sharing a given characteristic, trait or factor—such as those for which favorable scaled scores were given on particular days in large part based on assumptions regarding debits without well-established periodicity—are unexpectedly low, the retraining may weight or otherwise adjust reliance on those debit-related assumptions to more accurately reflect their impact on accurate scaled score generation.

Moreover, in one or more embodiments, metadata comprising significance indicators may be generated and transmitted to the merchant, as discussed in more detail in connection with method 600 above. Correlations or relationships between the significance indicators (e.g., reason codes) provided, and the circumstances and success of the attempted payment transactions reported back to the payment router, may reveal that merchant(s) often consider certain of the significance indicators as being better indicators of likelihood of settlement success than others as evidenced, for example, by the merchants' choices for processing the putative transactions and/or by the success thereof. Also or alternatively, the significance indicators may be kept internally by the payment router and used to derive such correlations or relationships and further the retraining process.

In one or more embodiments, determining the correlations and relationships used for retraining the scaled score algorithm may include computing a confusion matrix.

It should also be noted that a payment routing optimizer (PRO) recommendation may also be generated and output to the merchant by the payment router. More particularly, the payment router may include and/or execute a PRO algorithm which takes the scaled scores and additional data—such as, for example, costs associated with different payment rails, fraud likelihood scores computed according to other means, and other data—and outputs one or more PRO recommendations for each payment transaction message. The PRO recommendations may essentially distill the various scaled scores and other factors into a conclusive suggestion that the merchant attempts to process the payment in question on a certain day, on a certain rail, and otherwise according to the PRO recommendation(s). In such embodiments, the feedback data may indicate whether the recommendation was followed, whether the attempted transaction was successful, and other feedback data and utilize same to retrain the PRO recommendation algorithm and/or scaled score algorithm.

One of ordinary skill will appreciate that the retraining is preferably through use of the feedback data as labeled data in supervised learning operations. More particularly, the labeled data will reveal relationships between the likelihood of success in and other factors surrounding settlement of the putative payment transaction as embodied in the scaled scores, on the one hand, and the actual success observed in the attempted processing on the other hand.

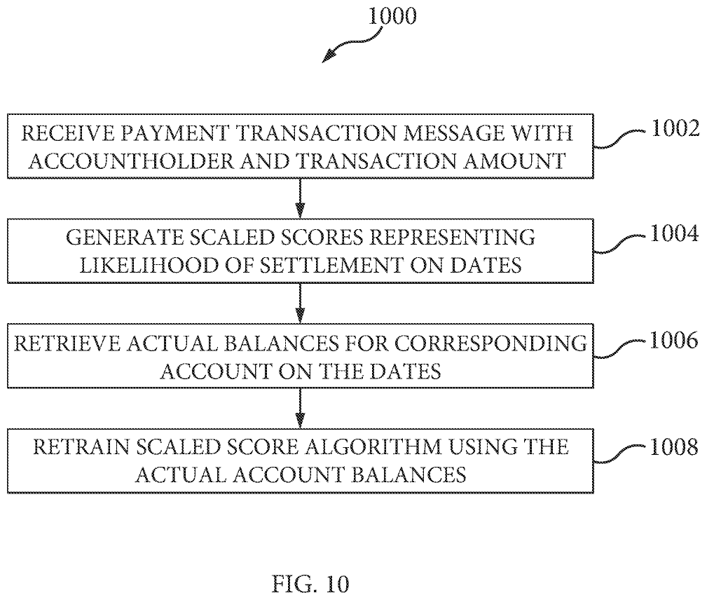

Referring to FIG. 10, a payment router and/or payment processor may perform one or more of the steps of the method 1000, and may generally correspond to and/or embody the computing device 102.

Referring to step 1002, the payment router may receive a payment transaction message with accountholder and transaction amount data. In one or more embodiments, the payment transaction message will describe a putative payment transaction between a merchant and a payer (i.e., accountholder) for the transaction amount. The merchant may transmit the payment transaction message.

Referring to step 1004, a scaled score representing a likelihood of settlement of the putative payment transaction may be generated. In one or more embodiments, the scaled score algorithm generates the scaled score in accordance with the method 400 described above. Moreover, a scaled score may be generated for a plurality of dates—typically but not necessarily occurring on consecutive business days—and/or for a plurality of payment rails. Put differently, a scaled score may be generated for each combination of a date and a payment rail. One of ordinary skill will appreciate that a scaled score may be generated for each unique combination of date and/or payment rail and one or more additional variables or factors—such as, for example, participating account(s) or other aspects of a putative transaction that are likely to impact likelihood of settlement—within the scope of the present invention.

Referring to step 1006, actual account balance data may be retrieved for the account on the dates for which the scaled scores were generated. In one or more embodiments, additional data, such as debits and credits from the account over the intervening time period since the transaction message, may also be retrieved. The actual account balance data may be retrieved periodically or on or after a last-occurring one of the dates for which scaled scores were generated in response to the payment transaction message. The actual account balance data may be retrieved from one or more of the merchant, a card issuer, the corresponding financial institution, an account data storage device and a database. For example, the actual account balance data may be transmitted from the financial institution holding the account to the payment router via an API maintained and/or accessible to, and/or that transmits data to, the payment router. Also or alternatively, the payment router may request the actual account balance data from an API maintained by the financial institution.

The transmission may be automated, and may occur intermittently, periodically, continuously and/or based on a trigger (e.g., approach or passage of the aforementioned last-occurring day in the group of potential dates for settlement). Moreover, each of the payment transaction message, the scaled scores, and the feedback data (and, optionally, the transaction request itself) may be labeled with a unique identifier (e.g., a unique alphanumeric code or the like) that may be used to link such data together with the same payment transaction message and automatically designate same for retraining processes.

Referring to step 1008, the actual account balance data may be used to retrain the scaled score algorithm. In one or more embodiments, the account balance prediction component of the scaled score algorithm—discussed in more detail above in connection with description of the scaled score 400 calculation—may be principally retrained with the actual account balance data. For example, overall actual account balance on a day for which a scaled score was calculated may be significantly different than that predicted by the account balance prediction component, revealing one or more flaws in the methodology implemented by the scaled score algorithm for calculating the predicted account balance. More particularly, one or more debits or credits may have been predicted or projected by the account balance prediction component, but may have not been realized in the account (as revealed by the actual account balance data), permitting corresponding adjustment of the scaled score algorithm. However, it is foreseen that other components of the scaled score algorithm—such as the general transactional behavior component—may be retrained based at least in part on the actual account balance data within the scope of the present invention.

Regression or clustering analyses techniques may be used to group factors or variables relied on by the scaled score algorithm and/or its account balance prediction component in generating the scaled scores. For example, regression may be used to evaluate the debit and credit data of the actual account balance data to determine periodicity for retraining.

For another example, wherever the actual account balance data reveal that success rates for attempted payment transactions sharing a given characteristic, trait or factor reflected in the actual account balance data—such as those for which favorable scaled scores were given on particular days in large part based on assumptions regarding debits without well-established periodicity—are unexpectedly low, the retraining may weight or otherwise adjust reliance on those debit-related assumptions to more accurately reflect their impact on accurate scaled score generation. More generally, the weight accorded any particular output or component of the scaled score algorithm may be changed through retraining, for example to reflect situations where periodicity of a debit or credit or grouping thereof is shown to be more or less reliable than originally anticipated based on analysis of the actual account balance data and/or where a dollar amount of a debit or credit influences the reliability of prediction of future instances of reoccurrence.

One of ordinary skill will appreciate that the retraining is preferably through use of the feedback data as labeled data in supervised learning operations. More particularly, the labeled data will reveal relationships between the likelihood of success in and other factors surrounding settlement of the putative payment transaction as embodied in the scaled scores, on the one hand, and the actual success observed in the attempted processing under the circumstances of the attempted processing.

In one or more embodiments, determining the correlations and relationships used for retraining the scaled score algorithm may include computing a confusion matrix.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by the inventor(s) includes the following:

We claim:

1. A system for payment routing according to a likelihood of settlement, the system comprising one or more processors and/or transceivers individually or collectively programmed to:
receive a payment transaction message relating to a putative payment transaction, the payment transaction message containing putative payment transaction data identifying an accountholder and a transaction amount corresponding to the putative payment transaction;
input historical transaction data for the accountholder and at least a portion of the transaction amount to a scaled score algorithm to generate a plurality of scaled scores for a plurality of corresponding potential settlement dates, each of the plurality of scaled scores representing the likelihood of settlement of the putative payment transaction from an account of the accountholder on the corresponding one of the plurality of potential settlement dates;
retrieve, from a financial institution corresponding to the account, actual account balances for the account on the plurality of corresponding potential settlement dates; and
retrain the scaled score algorithm using the actual account balances.

2. The system of claim 1, the one or more processors and/or transceivers being further individually or collectively programmed to maintain an application programming interface (API) configured to automatically receive the actual account balances and designate the actual account balances for the retraining.

3. The system of claim 1, wherein the scaled score algorithm includes a decision tree with boosted gradient trees.

4. The system of claim 3, wherein the retraining includes incorporating the actual account balances into a confusion matrix.

5. The system of claim 1, wherein the plurality of corresponding potential settlement dates includes a last-occurring date of the plurality of corresponding potential settlement dates, and the actual account balances are retrieved on or after the last-occurring date.

6. The system of claim 1, the one or more processors and/or transceivers being further individually or collectively programmed to retrain the scaled score algorithm using regression on additional historical data reflecting credits to and debits from the account to determine periodicity.

7. The system of claim 6, wherein the retraining using regression includes weighting the scaled score algorithm to emphasize the influence of the credits and the debits based on periodicity and/or dollar amount.

8. The system of claim 1, wherein the scaled score algorithm includes—
an account balance prediction component configured to, for each of the plurality of scaled scores, determine an existing account balance in an account of the accountholder and to analyze prior credits and debits of the historical transaction data for the account to project an account balance in the account on the corresponding one of the plurality of potential settlement dates,
a general transactional behavior component configured to analyze transactions of a plurality of accountholders to determine one or more factors impacting the projected account balance for the account on each of the plurality of corresponding potential settlement dates.

9. The system of claim 8, the one or more factors including a non-sufficient funds overdraft protection policy of a financial institution corresponding to the account.

10. A computer-implemented method for payment routing according to a likelihood of settlement, the method comprising, via one or more transceivers and/or processors:
receiving a payment transaction message relating to a putative payment transaction, the payment transaction message containing putative payment transaction data identifying an accountholder and a transaction amount corresponding to the putative payment transaction;
inputting historical transaction data for the accountholder and at least a portion of the transaction amount to a scaled score algorithm to generate a plurality of scaled scores for a plurality of corresponding potential settlement dates, each of the plurality of scaled scores representing the likelihood of settlement of the putative payment transaction from an account of the accountholder on the corresponding one of the plurality of potential settlement dates;
retrieving, from a financial institution corresponding to the account, actual account balances for the account on the plurality of corresponding potential settlement dates; and
retraining the scaled score algorithm using the actual account balances.

11. The method of claim 10, further comprising, via the one or more transceivers and/or processors, maintaining an application programming interface (API) configured to automatically receive the actual account balances and designate the actual account balances for the retraining.

12. The method of claim 11, wherein the scaled score algorithm includes a decision tree with boosted gradient trees.

13. The method of claim 12, wherein the retraining includes incorporating the actual account balances into a confusion matrix.

14. The method of claim 11, wherein the plurality of corresponding potential settlement dates includes a last-occurring date of the plurality of corresponding potential settlement dates, and the actual account balances are retrieved on or after the last-occurring date.

15. The method of claim 11, further comprising, via the one or more transceivers and/or processors, retraining the scaled score algorithm using regression on additional historical data reflecting credits to and debits from the account to determine periodicity.

16. The method of claim 15, wherein the retraining using regression includes weighting the scaled score algorithm to emphasize the influence of the credits and the debits based on periodicity and/or dollar amount.

17. The method of claim 11, wherein the scaled score algorithm includes—
an account balance prediction component configured to, for each of the plurality of scaled scores, determine an existing account balance in an account of the accountholder and to analyze prior credits and debits of the historical transaction data for the account to project an account balance in the account on the corresponding one of the plurality of potential settlement dates,
a general transactional behavior component configured to analyze transactions of a plurality of accountholders to determine one or more factors impacting the projected account balance for the account on each of the plurality of corresponding potential settlement dates.

18. The method of claim 17, the one or more factors including a non-sufficient funds overdraft protection policy of a financial institution corresponding to the account.

19. A non-transitory computer-readable storage media having computer-executable instructions for payment routing according to a likelihood of settlement stored thereon, wherein when executed by at least one processor the computer-executable instructions cause the at least one processor to:
receive a payment transaction message relating to a putative payment transaction, the payment transaction message containing putative payment transaction data identifying an accountholder and a transaction amount corresponding to the putative payment transaction;
input historical transaction data for the accountholder and at least a portion of the transaction amount to a scaled score algorithm to generate a plurality of scaled scores for a plurality of corresponding potential settlement dates, each of the plurality of scaled scores representing the likelihood of settlement of the putative payment transaction from an account of the accountholder on the corresponding one of the plurality of potential settlement dates;
retrieve, from a financial institution corresponding to the account, actual account balances for the account on the plurality of corresponding potential settlement dates; and
retrain the scaled score algorithm using the actual account balances.

20. The non-transitory computer-readable storage media of claim 19, wherein when executed by the at least one processor the computer-executable instructions further cause the at least one processor to maintain an application programming interface (API) configured to automatically receive the actual account balances and designate the actual account balances for the retraining.
